(19) United States
(12) Patent Application Publication
(10) Pub. No.: US 2006/0177800 A1
(43) Pub. Date: Aug. 10, 2006

(54) Edible Educational Aids

(75) Inventor: Raymond Floyd Wilkins, Easton, PA (US)

Correspondence Address: Raymond F. Wilkins, 307 W. Lafayette St., Easton, PA, 18042, US

(73) Assignee: Raymond Floyd Wilkins, Easton, PA (US)

(21) Appl. No.: 11/164,591

(22) Filed: Nov. 30, 2005

(51) Int. Cl. G09B 19/00

(52) U.S. Cl. 434/127

(57) ABSTRACT

An edible educational aid comprised of a body of edible material configured into the form of a recognizable object, and containing within its interior mass, an inner core of material designated to identify the object in which the body is configured to resemble. With the employment of the embodiments, the benefits of learning object recognition, spelling, reading, and mathematics are enjoyed thru the consumption of an edible article by a person, especially a child.

### CROSS-REFERENCE TO RELATED APPLICATION

Not applicable.

1. Field of the invention

This invention relates to the education of persons, especially children, and more particularly to the utilization of edible food articles especially configured to provide tools to aid in the function of learning. Even more particularly, this invention relates to especially configured edible articles designed to provide a basis for the learning of object recognition, spelling, reading, and arithmetic.

2. Description of the Prior Art

Various types of educational aids are known in the art of education. Tools designed to assist in the education of persons, especially children, are known to include; books, graphic illustration, devices designed to play verbal or sound instruction, devices designed to play visual instruction, puzzles, toys, games, and combinations of the previously mentioned.

A problem that can be encountered during the process of instilling information from an educating source to a person, especially a child, is the ability to capture and hold a child's attention to the source so that the information is effectively deciphered and stored in memory for the future utilization of the information.

Ideally, an efficient educational aid would include those in which a child enjoys participation with, and not one in which a child is demanded to participate with.

Additionally, included in the art are educational aids that may be more specifically designed to be utilized in a home environment involving a parent, sibling, or other adult. Problems that may typically cause below promised or unsatisfactory results in efficient educating may be due to; non-professional training in the use of, cost, complexity in the use of any aid comprised of electronics, and the time consumed by a person to educate one thru the use of a more complex home educational aid. Educational aids designed more specifically for home use which may not require as much adult intervention, typically in toy, puzzle and game forms, are usually lacking educational efficiency due to a child's attention being focused more so on their play values. Those types of aids that are designed to focus more their educational value typically loose efficiency due to imposing more work than a child's inherent instinct to play.

To this art is where the present invention is drawn towards as an improved means of communicating educational information, by combining the enjoyment of a good tasting snack, or reward food, and the function of educating.

There exists, known variations in the art of applying a secondary function to that of an edible article. One, as U.S. Pat. No. 6,221,407 issued to Gallart on Apr. 24, 2001, discloses a confectionary product to include a compartment for housing an object. A further variation would allow an edible article to function as an amusement device such as U.S. Pat. No. 4,397,871 issued to Meyer on Aug. 9, 1983, disclosed to utilize edible elements to function as a device for transmitting secret messages for use in child's play.

A still further variation, as U.S. Pat. No. 4,733,863 issued to Novotny on Mar. 29, 1988, discloses edible articles to function as components to a guessing game designed to test a participant's knowledge of confectionary flavor tastes. A still further variation would include those that disclose the use of edible articles as component parts to manually assemble the likeness of an object, therefore, acquiring an educational value thru an assembly or attachment process, such as, U.S. Pat. No. 5,731,020 issued to Russo on Mar. 24, 1998.

As previously described, there exists known inventions related to the art of educating, including some which suggest the use of food as a component for the process.

The advantages which the present invention contains, as compared to others known in the art would include; being self-contained, as not requiring any additional components to complicate function; easily comprehenable, so not to require complicated instructions to function; lack of complication allows efficient function due to limited distraction when utilizing; comparative compactness placing no limitations on location of use; and, relatively simple design controlling costs.

### SUMMARY OF THE INVENTION

The present invention is directed to the education of persons, especially children. When configured to include the preferred embodiments designed to enable the invention to teach the spelling of an object, the making of and the using of the invention would entail;

The body of an edible material, to be configured into the shape of a commonly recognizable object on the exterior. Thus, when the exterior surface material is ether opened, licked, or eaten through, an inner core, which is installed into the interior mass of the said body of exterior material by a suitable manufacturing method based on the edible material type and properties thereof, is revealed, and of a different coloration and/or edible material so to be visually distinguishable from the surrounding exterior material. This said inner core of edible material is configured to resemble the forms of letters, by a suitable manufacturing means based on material types and properties, which spells the word or words designated to describe the original object in which the said exterior body was configured to resemble. Therefore, the edible article is an educational aid to assist in the identification of, and the learning of the letters used to learn the proper spelling of the word used to describe the originally configured object the exterior resembled, thru the consumption of the article as a whole.

The present invention prescribes the use edible materials, especially those considered good tasting, to be effectively utilized to produce an edible article designed to aid in the administration of educational information to that of a person during the process of physically consuming the edible article. When the preferred embodiments of the present invention are employed, the invention possesses the ability to aid in the teaching of object recognition, spelling, reading, and arithmetic. Problems usually encountered in utilizing currently acceptable educational aids, especially those designed for in-home use, are typically related to complexity, cost, duration of parental intervention, restrictions in mobility, lacking diversified educational fields, and not effective in capturing a student's attention therefore limiting effectiveness. It is within these areas were the present invention possesses advantages in function.

It is therefore an object of the invention to provide an efficient and effective means of aiding in the delivery of educational information to that of a person, especially a child.

A further object of the invention is to consolidate an educational aid with a child's enjoyment of consuming a good tasting snack or reward food, exampled as, but not limited to; lollipops, candies, ice cream products, cakes, and the like.

A still further object of the invention is to provide an edible educational aid that can be used in the substitution of a commonly accepted snack or reward food absent of educational value, therefore, effectively controlling educational costs to the consumer.

### BRIEF DESCRIPTION OF THE DRAWINGS

FIG. 1 is a side view of an edible article configured to resemble the object of a Car on the exterior, and with a sectional erosion to reveal interior components.

FIG. 2 is an objective view of an edible article configured to resemble a rectangular object on the exterior, and containing visible indicia, and also depicts the object of a Dog as a centralized interior mass.

FIG. 3 is a frontal view of an edible article configured to resemble the object of a Dog on the exterior, included with a handle inserted into its mass containing indicia.

FIG. 4 is an objective view of an edible article configured to resemble a rectangular object on the exterior, and containing visible indicia, also including a handle, and containing the object of a number as a centralized mass of material.

FIG. 5 is an example of a containment article configured to resemble a cup, with a lid depicting the object of a Frog, and illustrated to be in the open position revealing an edible material with indicia visible within the material.

### DETAILED DESCRIPTION

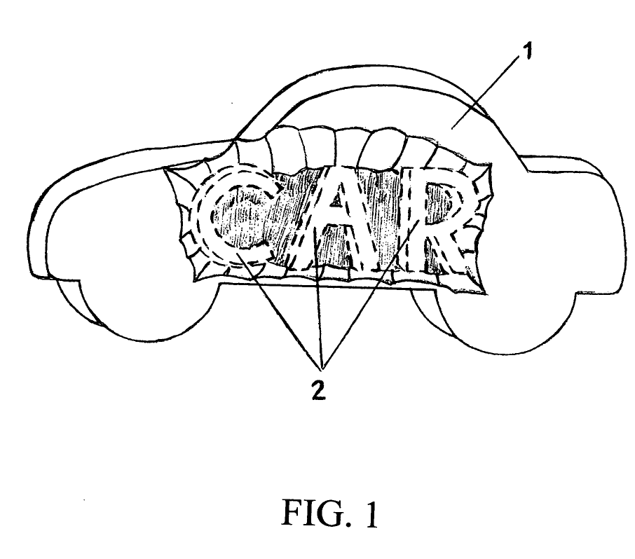

Referring to the drawings, and initially to the embodiment illustrated by FIG. 1, an edible educational aid in accordance to the present invention is constructed of a main body of edible material 1 configured into the shape or form of a commonly recognized object as an exterior view, by a manufacturing means suitably based on edible material type and properties thereof, and may also contain a variation in visual opacity.

And, an interior core 2 of edible or non-edible material which is installed within the interior mass of the main body of edible material 1 by a manufacturing means suitably based on material types and properties thereof, and configured into the form of an object of a different coloration and/or material so to be at least visually distinguishable from the surrounding main body of edible material 1.

In operation of the embodiment illustrated by FIG. 1, a person would proceed first by ether opening, eating, or licking into the main body of edible material 1, configured to resemble the object a Car of solid coloration in this example, therefore ultimately reaching and revealing the inner core 2 of material. The information provided by the inner core 2 of material is then available for comprehension by the person. The inner core 2 in this example is configured to contain the letters spelling the word Car, therefore enabling the person to learn the letters and the spelling of the word used to describe the object used in the original exterior configuration of the main body of edible material 1 during the process of consuming the article. Lastly, the person would consume the entirety of edible material, therefore benefiting from their nutritional values.

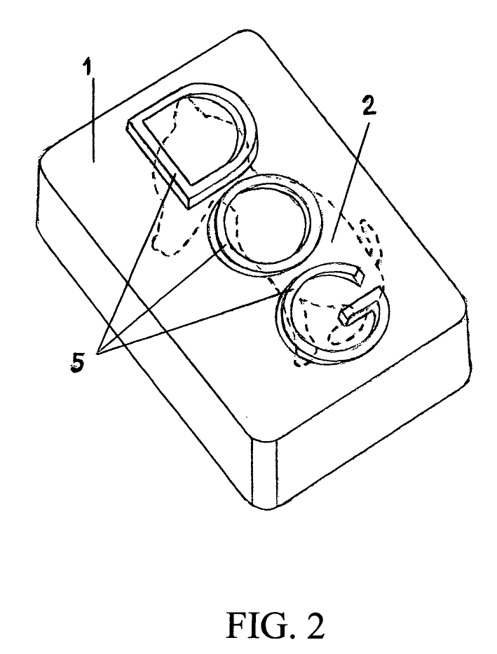

In a further embodiment in accordance to the present invention as illustrated by FIG. 2, an edible educational aid is constructed of; a main body of edible material 1 configured into a preferred shape or form of an object, based on market, edible material types, and/or manufacturing considerations thereof. Also, to include indicia 5 in the form of letters, words, symbols, numbers, or other, to be incorporated with or to be applied to the exterior surface of the main body of edible material 1 by a manufacturing means suitably based on the edible material type and properties thereof and, said indicia 5 to be visually identifiable from the exterior surface material of the main body of edible material 1 configuration.

Furthermore, an inner core 2 of edible or non-edible material which is installed within the interior mass of the main body of edible material 1 by a manufacturing means suitable based on material types and properties thereof, and to be configured into the shapes or forms of a commonly recognizable object by that process and, inner core 2 to be at least visually distinguishable from the surrounding exterior material of the main body of edible material 1.

In operation of the embodiment as illustrated by FIG. 2, a person would proceed by first, visually identifying the indicia 5 apparent on the exterior surface of the main body of edible material 1. As exampled in FIG. 2, the person is provided with the letters indicating the spelling the word Dog, which associates to that of an object. Secondly, a person would then proceed to open, eat, or lick into the main body of edible material 1, ultimately revealing the inner core 2 of material, which in this example is configured to resemble the object of a Dog. When the process of revealing the inner core 2 of material is completed by the person, the said person would receive educational benefit thru the verification of the object that is associated to the letters which formed the word they had learned, which identifies the object. Lastly, the person would complete the consumption of the remaining edible materials.

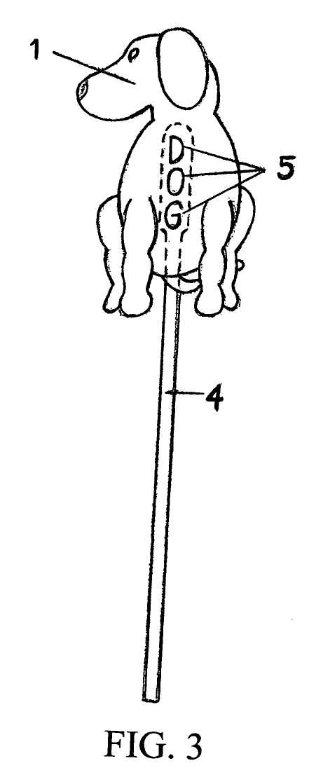

In a still further embodiment in accordance to the present invention as illustrated by FIG. 3, an edible educational aid is constructed of; a main body of edible material 1 configured into the shape or form of a commonly recognized object by a manufacturing means suitably based on edible material types and properties thereof. Additionally;

a supporting article of an edible and/or non-edible material designated as a handle 4 to be attached or inserted to hold on to the body of edible material 1, and to include an identifiable form of indicia 5 apparent from its surface configuration shape.

In operation of the embodiment as illustrated by FIG. 3, a person would proceed first by ether opening, eating, or licking into the main body of edible material 1, configured into the object of a Dog in this example, therefore ultimately exposing the indicia 5 contained on the handle 4. The information in which the person would reveal in this example would be the letters spelling the word Dog, therefore enabling the person to learn the letters and to spell the word used to describe the object utilized in the original exterior configuration of the main body of edible material 1. Lastly, the person would consume the remaining edible materials.

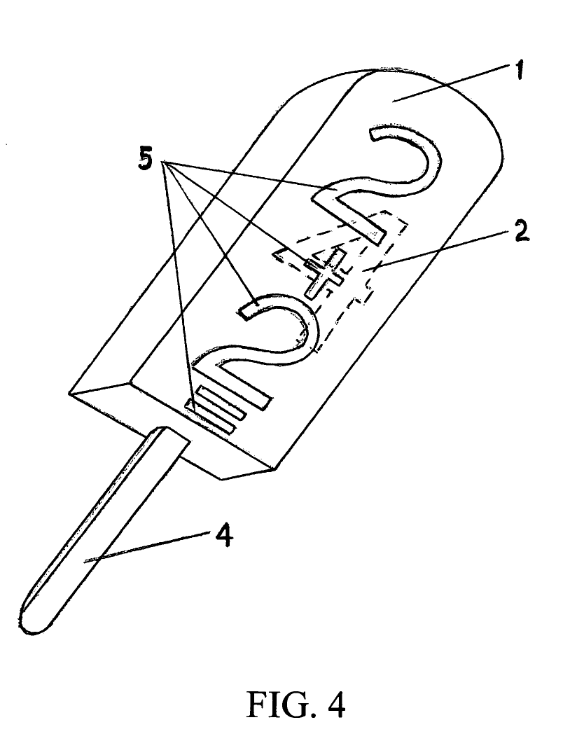

In a still further embodiment in accordance to the present invention as illustrated by FIG. 4, an edible educational aid is constructed of; a main body of edible material 1 to be configured into a preferred shape or form based on market, edible material types, properties, and manufacturing considerations thereof. And, to include indicia 5 in the form of letters, words, numbers, symbols, or other, to be incorporated with or applied to the exterior surface of the main body of edible material 1 by a manufacturing means suitably based on edible material types and properties thereof. Also, indicia 5 is designed to be visually identifiable from the surface material of the main body of edible material 1. And may also include a handle 4 based on use of materials. Furthermore;

an inner core 2 of edible or non-edible material which is installed within the interior mass of the main body of edible material 1 by a manufacturing means suitably based on material types and properties thereof, and to be configured to represent the form of an object by that process and to be at least of a different coloration and/or material so as to be at least visually distinguishable from the surrounding main body of edible material 1.

In operation of the embodiment as illustrated by FIG. 4, a person would proceed first by securing the edible article in hand by use of the handle 4. Secondly, would visually identify and comprehend the indicia 5 apparent on the exterior surface of the main body of edible material 1. As exampled in FIG.4, the person is provided with the mathematical problem 2+2=. Thirdly, the person would proceed to open, lick, or eat into the main body of edible material 1, ultimately reaching the inner core 2 of material. In this example the person would reveal the number four as the form of the inner core 2 of material. Thru the process of exposing the inner core 2, the person would receive the educational benefit of revealing the answer to the problem which was asked on the surface of the main body of edible material 1. The math equation learned by the person in this provided example is 2+2=4. Lastly, the person would consume the remaining edible materials.

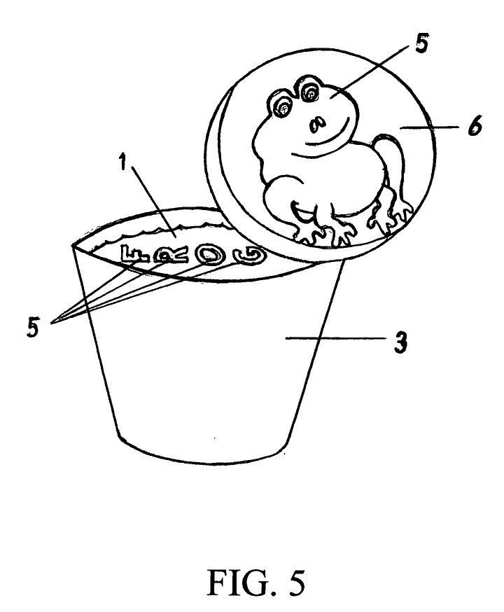

In a still further embodiment in accordance to the present invention as illustrated by FIG. 5, an edible educational aid is constructed by; an edible or non-edible containment article 3 which is configured into a determined shape or form by a manufacturing means suitably based on material types and properties thereof, and if required based on article configuration, to include a edible or non edible sealing lid 6. And, to include indicia 5 applied to the exterior of the containment article 3 or as exampled in FIG. 5, the lid 6, and provided to be externally visible. The containment article 3 is to contain;

a main body of edible material 1. Included in the main body of edible material 1 is the application of a secondary body of edible or non-edible material ether applied to or installed within the main body of edible material 1 by a method suitably based on material types and properties thereof, and as exampled in FIG. 5, configured as indicia 5, and to be visually identifiable from the surrounding main body of edible material 1 by the use of a material of a different coloration and/or type.

In operation of the embodiment as illustrated by FIG. 5, a person would first identify and comprehend the indicia 5 apparent on the exterior, as in this provided example a picture of the object of a Frog is applied to the exterior surface of the lid 6. Secondly, the person, would ether open, eat, or lick through the lid 6, dependent upon material composition, gaining exposure to the main body of edible material 1 within the containment article 3. As exampled by FIG. 5 a secondary body of edible material configured to resemble the forms of the letters which spell the word Frog are identified as being visible to the person, therefore enabling the person to learn the letters used to spell the word which describes the object of a Frog as identified on the surface of the lid 6. Upon the completion of the provided educational lesson, the person would then proceed in consuming the remaining edible material in the containment article 3.

Edible educational aids have been described herein with reference to the preferred embodiments for comprehension. Depictions are set forth to example the preferred embodiments and not intended to place limitations on objects, dimension, visual appearances, materials, or other. Modifications and enhancements can be made without departing from the spirit and scope of the invention as set forth in the claims.

What is claimed is:

1. An edible educational aid comprised of; a body of edible material configured to resemble the form of a recognizable object, and to contain within its interior mass; a core, of an edible material to be of a different coloration so as to be visually distinguishable from the surrounding material of said body, and configured to resemble the forms of letters, which spell words designated to describe the object of which the said body is configured to indicate.

2. The edible educational aid as set forth in claim 1, wherein the said body of edible material contains identifying indicia, apparent from its exterior surface.

3. The edible educational aid as set forth in claim 1, wherein the said body of edible material contains indicia indicative of a math equation, apparent from its exterior surface.

4. The edible educational aid as set forth in claim 1, wherein the said body of edible material is transparent.

5. The edible educational aid as set forth in claim 1, wherein the said body of edible material is translucent.

6. The edible educational aid as set forth in claim 1, wherein the said core material is non-edible.

7. The edible educational aid as set forth in claim 1, wherein the said core material is configured to resemble the form of a recognizable object.

8. The edible educational aid as set forth in claim 1, wherein the said core material is configured to resemble the forms of numbers.

9. The edible educational aid as set forth in claim 1, wherein to incorporate a handle of a non-edible material, designed for holding.

10. The edible educational aid as set forth in claim 9, wherein said handle is of an edible material.

11. The edible educational aid as set forth in claim 9, wherein said handle is configured to resemble the form of a recognizable object.

12. The edible educational aid as set forth in claim 9, wherein said handle is to include indicia, apparent from its exterior surface.

13. An edible educational aid comprised of; a containment article of non-edible material configured to resemble the form of a recognizable object, and to include an operational sealing component designed to seal the interior from exposure to the ambient environment; and
to contain a body of edible material, to which itself includes; an
additional installation of an edible material to be of a different coloration so as to be visually distinguishable from the surrounding said body of edible material and configured to resemble the forms of letters, which spell words designated to describe the object of which the said containment article is configured to indicate.

14. The edible educational aid as set forth in claim 13, wherein said containment article including said sealing component, is of an edible material.

15. The edible educational aid as set forth in claim 13, wherein said containment article including said sealing component, contains indicia, apparent from its exterior surface.

16. The edible educational aid as set forth in claim 13, wherein said containment article including said sealing component, contains indicia indicative of a math equation, apparent from its exterior surface.

17. The edible educational aid as set forth in claim 13, where said containment article including said sealing component, material is transparent.

18. The edible educational aid as set forth in claim 13, wherein said containment article including said sealing component, material is translucent.

19. The edible educational aid as set forth in claim 13, wherein said body of edible material is transparent.

20. The edible educational aid as set forth in claim 13, wherein said body of edible material is translucent.

21. The edible educational aid as set forth in claim 13, wherein said additional installation of material is non-edible.

22. The edible educational aid as set forth in claim 13, wherein said additional installation of material is configured to resemble the form of a recognizable object.

23. The edible educational aid as set forth in claim 13, wherein said additional installation of material is configured to resemble the form of numbers.
